(19) United States
(12) Patent Application Publication
(10) Pub. No.: US 2013/0117796 A1
(43) Pub. Date: May 9, 2013

(54) REDUNDANT KEY FRAME TRANSMISSION

(71) Applicant: Honggang Qi, Beijing (CN)

(72) Inventor: Honggang Qi, Beijing (CN)

(73) Assignee: EMPIRE TECHNOLOGY DEVELOPMENT LLC, Wilmington, DE (US)

(21) Appl. No.: 13/520,440

(22) PCT Filed: Nov. 7, 2011
(86) PCT No.: PCT/US2011/059632

§ 371 Date: Jul. 3, 2012

(51) Int. Cl. H04N 21/25

(52) U.S. Cl. 725/116

(57) ABSTRACT

Technologies are generally described for mitigating or eliminating the effects from data loss. In an example, a data transmission system may be configured to send a data stream to a receiving device over a first data transmission path. The data transmission system may also be configured to send data representing key frames included in the data stream to a redundancy transmission device over a second data transmission path. The redundancy transmission device may be configured to transmit key frames to the receiving device in response to a loss of data.

### BACKGROUND

Systems that transmit data such as, for example, compressed video data, may use a wireless video transmission system for transmitting the data to a receiving device for decompression, decoding, and rendering. However, loss of data in the event of noise interference in the transmission channel can result in a data stream that cannot be fully decoded, resulting in lost video frames and poor video quality. Such a scenario can also occur in wired transmission systems when data is lost through interference, network device malfunctions, and the like. The result will be a reduction or loss of data quality and the inability for applications using the data to function properly.

### SUMMARY

In various embodiments, methods and systems for transmitting data are disclosed. In one embodiment, a data transmission system is configured to transmit a data stream to a receiving device over a first data transmission path. The data transmission system may also be configured to transmit data representing key frames included in the data stream to a redundancy transmission device over a second data transmission path. The redundancy transmission device is configured to transmit key frames to the receiving device in response to a loss of data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 depicts an example of an encoding system.

FIG. 2 depicts an example of a decoding system.

FIG. 3 depicts an illustration of the use of key frames.

FIG. 4 depicts an example system wherein aspects of the present disclosure can be implemented.

FIG. 5 illustrates an example of an operational procedure for facilitating remote user control of machine implemented tasks.

FIG. 6 illustrates an example of an operational procedure for facilitating remote user control of machine implemented tasks.

FIG. 7 illustrates an example of an operational procedure for facilitating remote user control of machine implemented tasks.

FIG. 8 illustrates an example of an operational procedure for facilitating remote user control of machine implemented tasks.

FIG. 9 depicts an example computing system wherein aspects of the present disclosure can be implemented.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

In an illustrative embodiment, any of the operations, processes, etc. described herein can be implemented as computer-readable instructions stored on a computer-readable medium. The computer-readable instructions can be executed by a processor of a mobile unit, a network element, and/or any other computing device.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

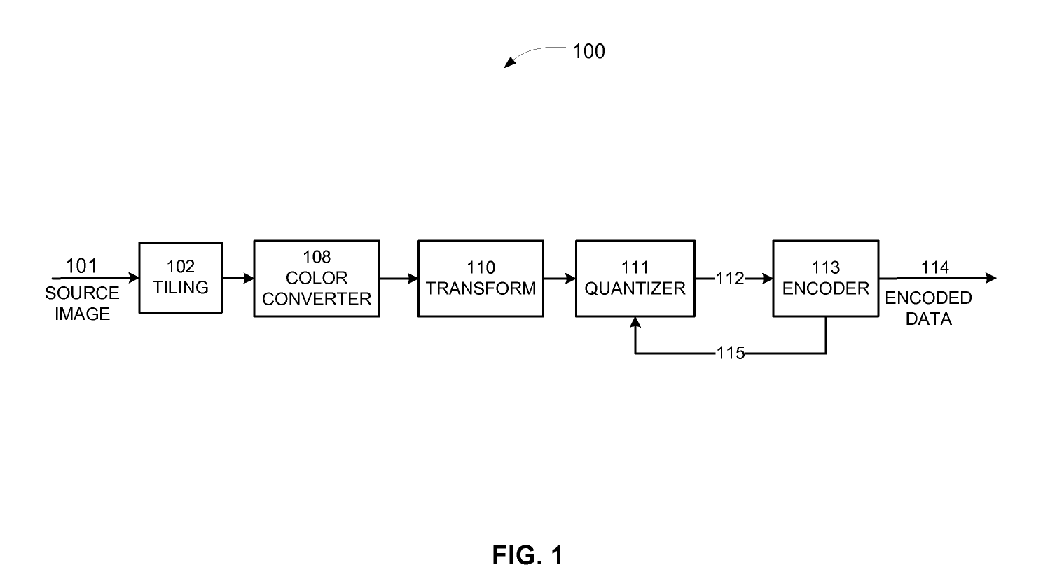

Referring to FIG. 1, a block diagram of an encoding system 100 is shown, in accordance with one embodiment of the present disclosure. In alternate embodiments, encoding system 100 may be implemented using components and configurations in addition to, or instead of, certain of those components and configurations discussed below in conjunction with the FIG. 1 embodiment. For example, encoding system 100 is discussed in the context of processing video data. However, in alternate embodiments, certain concepts and techniques from the present disclosure may be similarly utilized for processing other types of electronic data.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

In the FIG. 1 embodiment, encoding system 100 may initially receive a source image 101 as a frame of image data from any appropriate data source. A color converter 108 may convert the image data from a first color format to a second color format that is appropriate for further processing by encoding system 100. For example, in certain embodiments, source image 101 may initially be received in an RGB format that color converter 108 converts into a corresponding YUV format.

A transform module 110 may perform a transformation process such as, for example, a discrete wavelet transform procedure, on the output of the color converter 103 to transform the individual color components into sub bands. A quantizer module 111 may perform a quantization procedure by utilizing appropriate quantization techniques to compress the sub bands. In the FIG. 1 embodiment, quantizer 111 may produce compressed image data 112 by reducing the bit rate of the image data according to a particular compression ratio that may be specified by an adaptive quantization parameter 115 received via a feedback loop from encoder 113.

Encoder 113 may perform an encoding procedure such as an entropy encoding procedure to generate encoded data 114. In some embodiments, the encoding procedure may further reduce the bit rate of the compressed image data by substituting appropriate codes for corresponding bit patterns in the compressed image data received from quantizer 111.

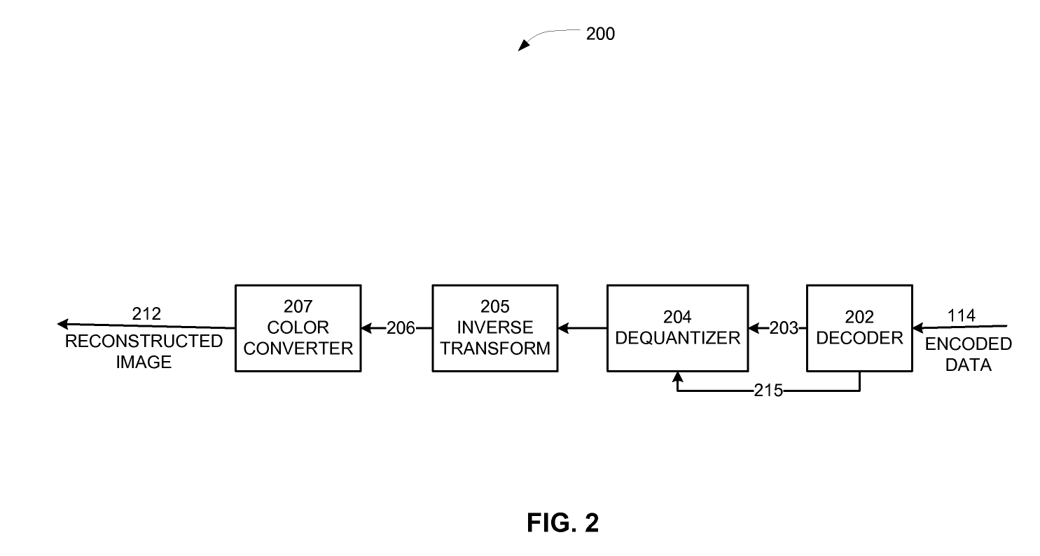

Referring now to FIG. 2, a block diagram of a decoding system 200 is shown, in accordance with one embodiment of the present disclosure. In alternate embodiments, decoding system 200 may be implemented using components and configurations in addition to, or instead of, certain of those components and configurations discussed in conjunction with the FIG. 2 embodiment. For example, in the FIG. 2 embodiment, decoding system 200 is discussed in the context of processing video data. However, in alternate embodiments, certain concepts and techniques from the present disclosure may be similarly utilized for processing other types of electronic data.

In the FIG. 2 embodiment, decoding system 200 may initially receive encoded data 114 that is provided from one or more data sources in an appropriate encoding format. A decoder 202 may perform a decoding procedure to convert encoded data 114 into compressed image data 203. In certain embodiments, the decoding procedure increases the bit rate of encoded data 114 by substituting appropriate bit patterns for corresponding codes in the encoded data 114 to produce compressed image data 203 in a color format.

A dequantizer module 204 may perform a dequantization procedure by utilizing appropriate dequantization techniques to decompress the compressed image data 203 to produce corresponding sub bands. For example, in certain embodiments, dequantizer 204 may produce the sub bands by performing dequantization based upon the quantization setting of quantizer 111 during encoding. In the FIG. 2 embodiment, an inverse transform module 205 may perform a known inverse transformation procedure to reverse a corresponding transformation procedure by converting sub bands into corresponding image data that is output on path 206.

A color converter 207 may then convert the image data from a first color format to a second color format for further processing by decoding system 200. For example, in certain embodiments, the image data received by color converter 207 may be converted from a YUV format into a corresponding RGB format.

Existing systems that transmit data such as, for example, compressed video data, may use a wireless video transmission system for transmitting the data to a receiving device for decompression, decoding, and rendering. However, a wireless video transmission system typically only uses a single channel for transmitting data. The use of only a single channel may lead to loss of data in the event of noise interference in the channel, and the loss of data can result in a video data stream that cannot be fully decoded, resulting in lost video frames and the like. Such a scenario can also occur in wired transmission systems when data is lost through interference, network device malfunctioning, and the like. The result will be a reduction or loss of data quality and the inability for applications using the data to function properly.

The effects of data loss are exacerbated when the lost data involves key frames. Key frames generally refer to image data that provide reference information for non-key frames and thus act as reference frames in data encoding and decoding. In particular, many video encoding schemes interpolate data in between key frames. Thus when one or more key frames are lost, the decoding process can be hampered by incorrect decoding of a relatively large range of video images due to the loss of the key frames. The loss of these key frames can result in the loss of ability to interpolate between significant video frames resulting in uneven video reproduction.

A key frame typically defines the starting and ending points of a transition. For example, sequence of key frames may be used to define the movement in a sequence while the position of the key frames may define the timing of the movement. Key frames may thus be used to create the perception of movement and additional frames may be filled in based on the key frames.

In video compression the key frame is a frame in which a complete image is stored in the video data stream. Since video sources typically exhibit small changes in the image from one frame to the next, only changes that occur from one frame to the next can be stored in the data stream in order to reduce the amount of data that must be encoded and transmitted. When a significant change in the image occurs or when a scene changes, a key frame is created. The key frame representing the entire image is output when the visual difference between two frames is so great that representing the new image incrementally from the previous frame would be more complex and would require more data than reproducing the entire image.

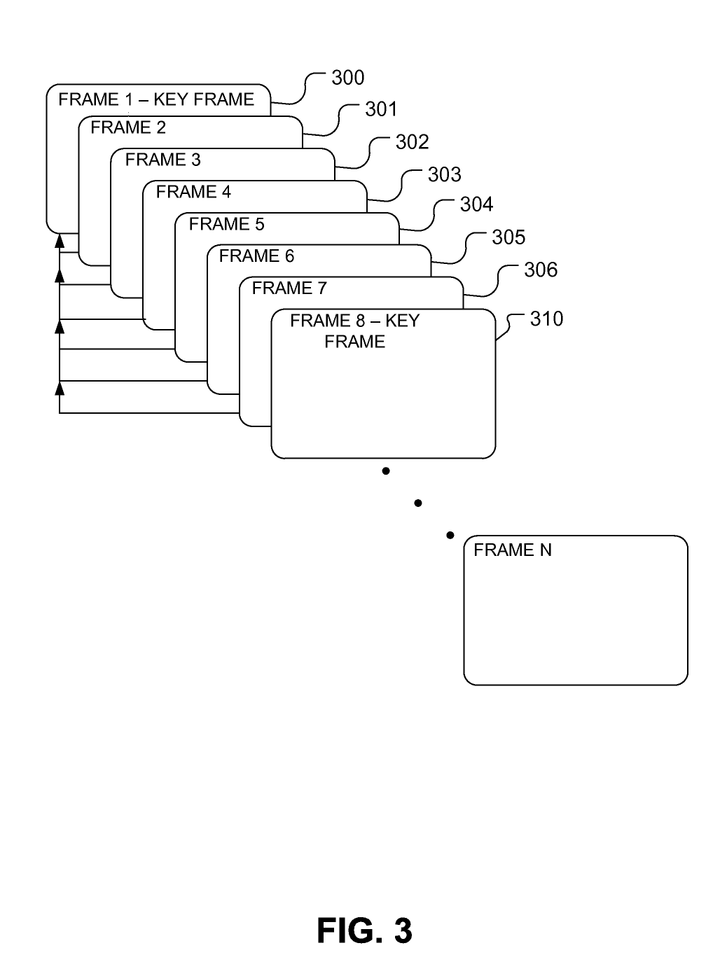

FIG. 3 depicts an example illustration of the use of key frames in video data. As depicted, frame 1 (300) is a key frame and frames 2 through frame 7 (301 through 306) are frames that are generated based on key frame 1 (300). In this example, every eighth frame is a key frame, and thus frame 8 is another key frame (310). As can be seen, if frame 1 (300) is lost, then frames 2 through frame 7 (301 through 306) cannot be decoded and rendered properly, and thus no video will be available until the next available key frame 310.

As mentioned, in video compression only incremental changes between frames are stored except for the key frame data. Accordingly, when data is lost, it is not possible to recreate an arbitrary point in the video stream without the key frame data because the data in a given frame only represents the differences between that frame and the key frame. It is therefore necessary to include key frames at sufficient intervals when encoding video data. For example, a key frame may be output once for every eight seconds of video even when the video image does not change sufficiently visually to warrant the creation of the key frame. In this way, the decoding system can recreate a point in the video stream at a minimum of eight second intervals.

If a key frame is lost during transmission, then subsequent images or frames that reference the lost key frame will not be decoded correctly during the decoding process, resulting in distortion or frozen video images for a period of time. In the case of the wireless transmission of video signals, the unreliability of channel transmission can result in the loss of data packets due to interference and other causes. Similar issues can result from wired transmission when part of the network is unreliable or due to congestion and other factors. As a result, decoders will not be able to correctly decode the video images and users will not be able to browse or view the videos for a time. If such loss of video key frame data occurs frequently, the video quality of large sections of video may be affected and degraded, resulting in a poor user experience. Accordingly, reducing the packet loss rate of key frames can be very effective in improving the quality of video images that are transmitted over an unreliable channel.

Disclosed herein are technologies, including methods and systems that can be used to mitigate or eliminate the effects from decoding errors when decoding video images by deploying a dedicated redundancy forwarding device for key frames. Such a device can be added without the need for extensive modification to existing video transmission systems and without significantly increasing the complexity of decoder devices. In one embodiment, the loss of key frames in video decoding can be reduced by adding a redundancy transmission device for video key frames in a wireless video transmission system so as to increase the likelihood that key frames are available to the decoder devices. Redundant transmission of key frame data can reduce or eliminate the loss of key frames, allowing decoding of the video data without significant loss and reducing the video effects such as discontinuities and other deterioration of video quality.

In one embodiment, a redundancy transmission device is provided to operate in conjunction with a wireless video transmission system. The redundancy transmission device can be any appropriately configured device that can receive key frame data, store the key frame data, and transmit the key frame data as needed. In some embodiments, the redundancy transmission device can be a dedicated router or a server. In one embodiment, an encoded video stream can be transmitted to the decoder terminal via a first channel, and the key frame data of the encoded video stream can also be transmitted to the redundancy transmission device via a second channel. The second channel can be any alternative channel that provides a diverse data transmission path for the data such that a failure of the first channel will not result in a failure of the second channel.

When it is determined that some of the video data transmitted to the decoder terminal via the first channel has been lost, the redundancy transmission device may be notified and the redundancy transmission device may transmit key frame data corresponding to the lost video data to the decoder terminal. The decoder terminal is configured to receive the retransmitted key frame data from the redundancy device and the key frame data can be used to recover the missing video data. Accordingly, deterioration or loss of video quality due to the data loss can be minimized or avoided and a more seamless video experience can be provided.

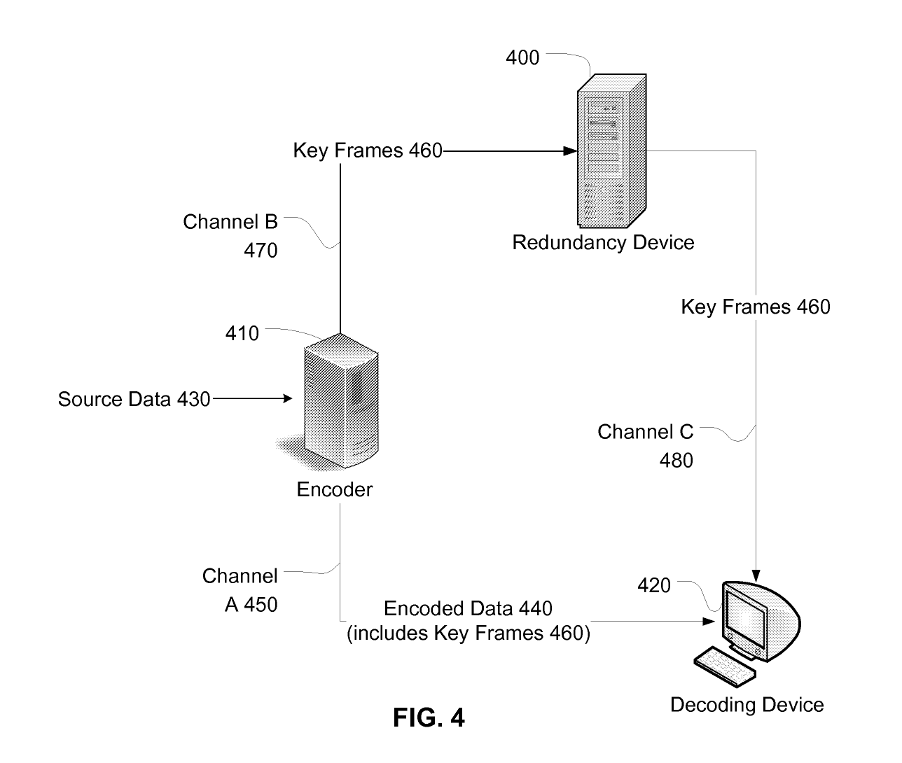

FIG. 4 illustrates an example architecture for implementing aspects of the present disclosure. As depicted, an encoding system 410 may be configured to encode source data 430 into encoded data 440, and transmit encoded data 440 to a decoding device 420 via a data channel 450. In some embodiments, source data 430 can be a video data stream. However, source data 430 can include other data such as audio and other media types. In some embodiments, data channel 450 can be a wireless data channel. Other data transmission media are also contemplated by the present disclosure including wired transmission. Wireless transmission can include 802.11n, Bluetooth, and other wireless transmission methods.

Key frames 460 are also transmitted to a redundancy device 400 via channel 470. Redundancy device 460 can be any computing device capable of receiving data and store the data for retransmission at another time. Channel 470 can be another channel that provides a diverse transmission path for key frames 460. Typically it is desirable for channel 470 to be another physical channel for diversity purposes. For example, in a wired scenario, channel 470 can be another network transmission path that transmits data via another path including alternative routers and other network devices. In a wireless scenario, channel 470 can be another wireless channel that uses an alternative transmission frequency or time division slot.

Channel 480 may be used by the redundancy device 400 to transmit key frames 460 to the decoding device 420 when data is lost during transmission between encoder 410 and decoding device 420. In one embodiment, a request may be sent from decoding device 420 to redundancy device 400 to request a retransmission of one or more of key frames 460 when it is determined that some of the data was lost during transmission. This determination can be performed by decoding device 420, encoder 410, or redundancy device 400.

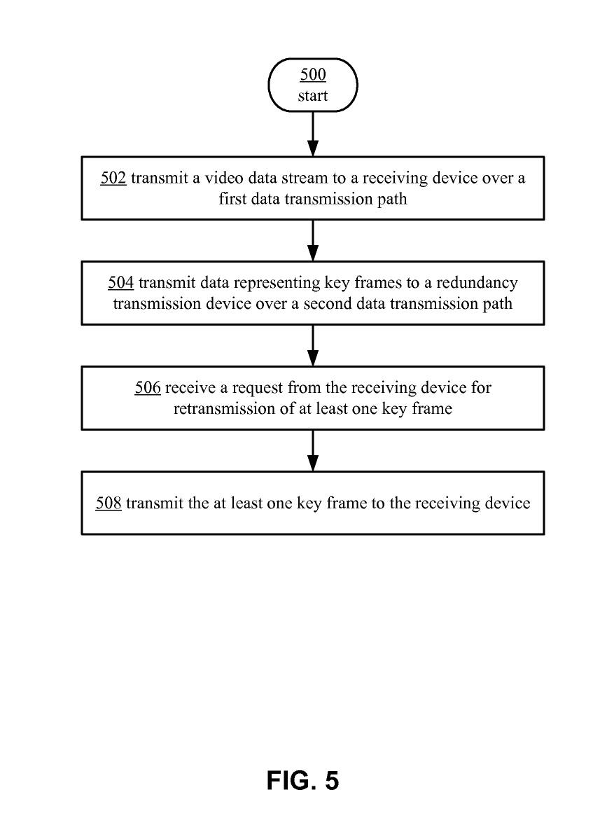

FIG. 5 depicts an example operational procedure for transmitting video data including operations 500, 502, 504, 506, and 508. Referring to FIG. 5, operation 500 begins the operational procedure and, at operation 502 a video data stream is transmitted to a receiving device over a first data transmission path. In one embodiment, the video data stream can be transmitted by a video transmission system that is configured to receive source video data and transmit the source video data and produce a video data stream. The video data stream may include video frame data including key frames as described above. The first data transmission path may be a wired or wireless transmission medium. The receiving device can be any device configured to receive the video data stream such as a computing device executing video rendering software or a dedicated video decoder. Operation 502 may be followed by operation 504.

At operation 504, data representing one or more key frames included in the video data stream is transmitted, by the video transmission system, to a redundancy transmission device over a second data transmission path. The redundancy transmission device can be a network device or computing device that is configured to receive the key frames and store the key frames for subsequent retransmission. The key frames may, for example, be stored in one or more memories. Operation 504 may be followed by operation 506.

At operation 506, a request from the receiving device for retransmission of at least one key is received by the redundancy transmission device. For example, if some of the video data stream was not received by the receiving device, then a request for key frames can be generated and sent to the redundancy transmission device. In an embodiment, the requested key frames can be those associated with the lost video data. In one embodiment, the request can be generated by the video transmission system. In another embodiment, the request can be generated by the receiving device. Operation 506 may be followed by operation 508.

At operation 508, the requested key frames are transmitted to the receiving device in response to the request.

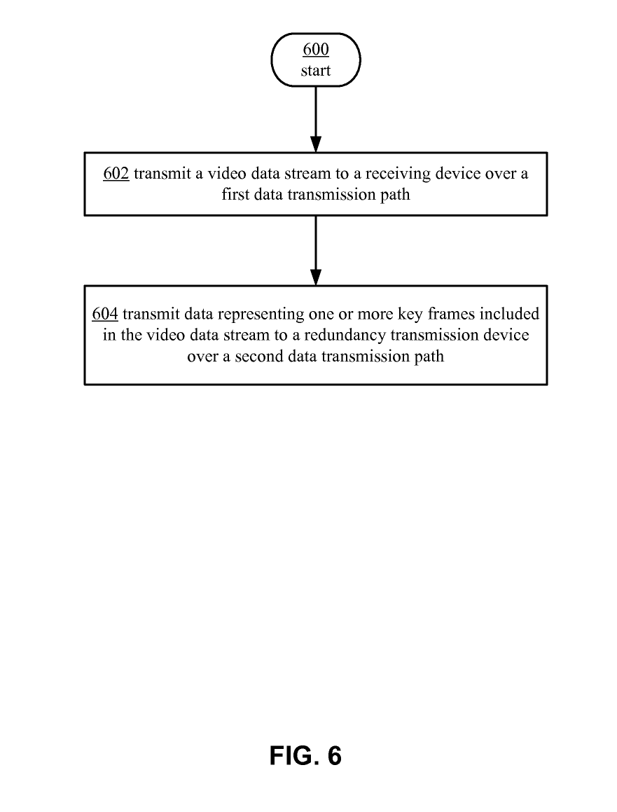

FIG. 6 depicts another example operational procedure for transmitting video data including operations 600, 602, and 604. Referring to FIG. 6, operation 600 begins the operational procedure and, at operation 602 a video data stream is transmitted by a video transmission system to a receiving device over a first data transmission path. Operation 602 may be followed by operation 604. At operation 604 data representing one or more key frames included in the video data stream is transmitted by the video transmission system to a redundancy transmission device over a second data transmission path. In an embodiment, the redundancy transmission device can be configured to transmit at least one key frame to the receiving device in response to a request for retransmission of the at least one key frame.

In one embodiment, the video data stream and the data can be transmitted wirelessly. For example, the first and second data transmission paths can be different wireless channels or links. For example, the first and second data transmission paths can be different bands in a frequency division duplex system, or different channels in a time division duplex system.

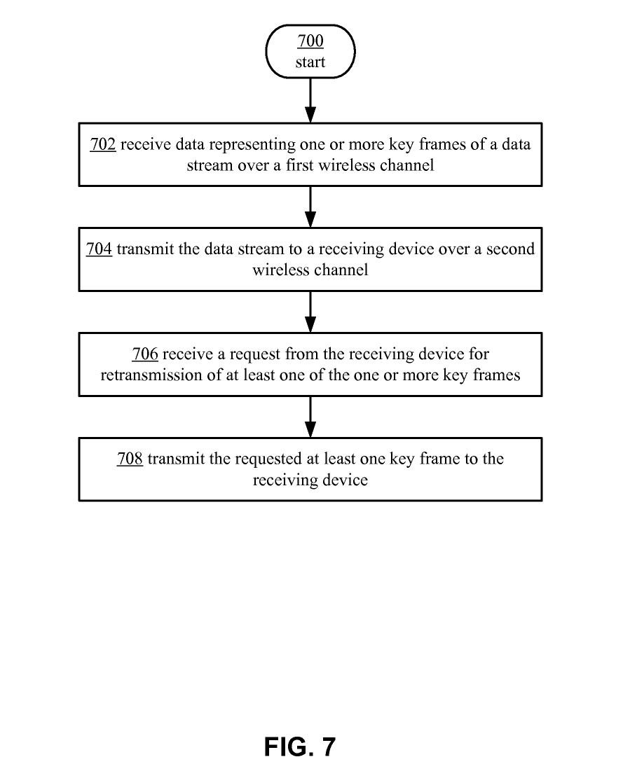

FIG. 7 depicts an example operational procedure for facilitating wireless data transmission including operations 700, 702, 704, 706, and 708. Referring to FIG. 7, operation 700 begins the operational procedure and, at operation 702, data representing one or more key frames of a data stream is received over a first wireless channel. The key frames can refer to any reference frame data that can be used to interpolate intermediate frames given information that describes changes between the key frames. Accordingly, the present disclosure is not limited to video data transmission and can be applied to any data transmission scenario in which loss of data can occur. Operation 702 may be followed by operation 704.

At operation 704, the data stream is transmitted to a receiving device over a second wireless channel. Operation 704 may be followed by operation 706. At operation 706, a request is received from the receiving device for retransmission of at least one of the one or more key frames. Operation 706 may be followed by operation 708. At operation 708, the requested at least one key frame is transmitted to the receiving device in response to the request.

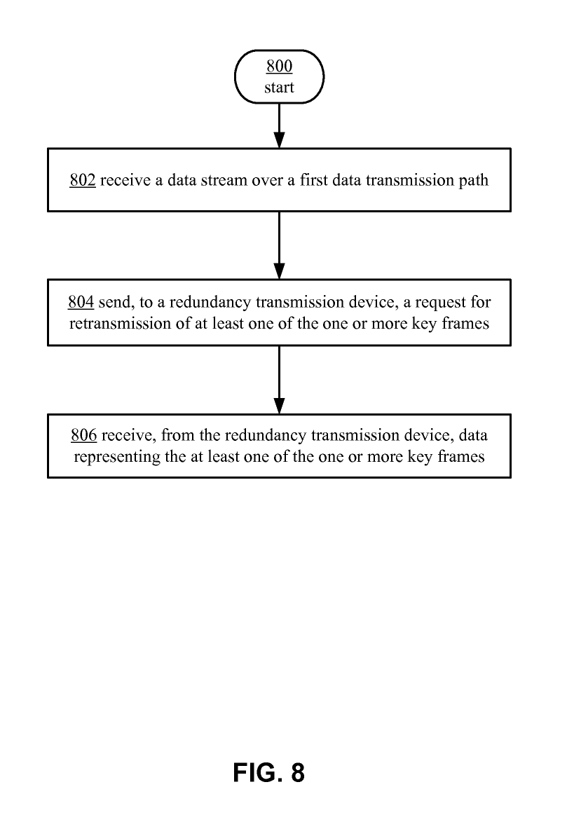

FIG. 8 depicts another example operational procedure for facilitating wireless data transmission including operations 800, 802, 804, and 806. Referring to FIG. 8, operation 800 begins the operational procedure and, at operation 802, a data stream is received from a data transmission system over a first data transmission path, the data stream including one or more key frames. Operation 802 may be followed by operation 804.

At operation 804, a request for retransmission of at least one of the one or more key frames is sent to a redundancy transmission device. In an embodiment, the one or more key frames may be received by the redundancy transmission device from the data transmission system over a second data transmission path. Operation 804 may be followed by operation 806.

At operation 806, data representing the at least one of the one or more key frames is received from the redundancy transmission device.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

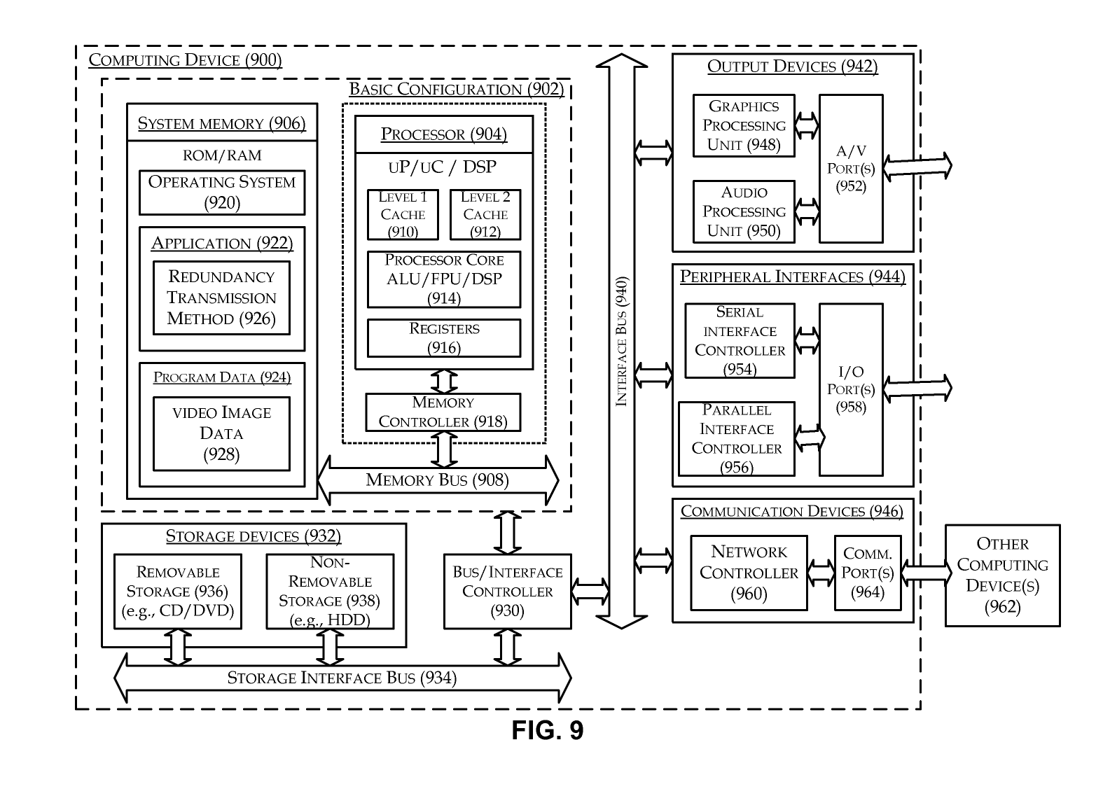

FIG. 9 is a block diagram illustrating an example computing device 900 that is arranged for redundant key frame transmission in accordance with the present disclosure. In a very basic configuration 902, computing device 900 typically includes one or more processors 904 and a system memory 906. A memory bus 908 may be used for communicating between processor 904 and system memory 906.

Depending on the desired configuration, processor 904 may be of any type including but not limited to a microprocessor (LIP), a microcontroller (gC), a digital signal processor (DSP), or any combination thereof Processor 904 may include one more levels of caching, such as a level one cache 910 and a level two cache 912, a processor core 914, and registers 916. An example processor core 914 may include an arithmetic logic unit (ALU), a floating point unit (FPU), a digital signal processing core (DSP Core), or any combination thereof An example memory controller 918 may also be used with processor 904, or in some implementations memory controller 918 may be an internal part of processor 904.

Depending on the desired configuration, system memory 906 may be of any type including but not limited to volatile memory (such as RAM), non-volatile memory (such as ROM, flash memory, etc.) or any combination thereof System memory 906 may include an operating system 920, one or more applications 922, and program data 924. Application 922 may include a redundancy transmission method 926 that is arranged to perform the functions as described herein including those described with respect to process described, for example, in FIG. 5. Program data 924 may include video image data 928 that may be useful for operation with the redundant key frame transmission method described above. In some embodiments, application 922 may be arranged to operate with program data 924 on operating system 920 such that that implementations of redundant key frame transmission may be provided as described herein. This described basic configuration 902 is illustrated in FIG. 9 by those components within the inner dashed line.

Computing device 900 may have additional features or functionality, and additional interfaces to facilitate communications between basic configuration 902 and any required devices and interfaces. For example, a bus/interface controller 930 may be used to facilitate communications between basic configuration 902 and one or more data storage devices 932 via a storage interface bus 934. Data storage devices 932 may be removable storage devices 936, non-removable storage devices 938, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 906, removable storage devices 936 and non-removable storage devices 938 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 900. Any such computer storage media may be part of computing device 900.

Computing device 900 may also include an interface bus 940 for facilitating communication from various interface devices (e.g., output devices 942, peripheral interfaces 944, and communication devices 946) to basic configuration 902 via bus/interface controller 930. Example output devices 942 include a graphics processing unit 948 and an audio processing unit 950, which may be configured to communicate to various external devices such as a display or speakers via one or more A/V ports 952. Example peripheral interfaces 944 include a serial interface controller 954 or a parallel interface controller 956, which may be configured to communicate with external devices such as input devices (e.g., keyboard, mouse, pen, voice input device, touch input device, etc.) or other peripheral devices (e.g., printer, scanner, etc.) via one or more I/O ports 958. An example communication device 946 includes a network controller 960, which may be arranged to facilitate communications with one or more other computing devices 962 over a network communication link via one or more communication ports 964.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 900 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 900 may also be implemented as a personal computer including both laptop computer and non-laptop computer configurations.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method for transmitting video data, comprising:
transmitting, by a video transmission system, a video data stream to a receiving device over a first data transmission path;
transmitting, by the video transmission system, data representing one or more key frames included in the video data stream to a redundancy transmission device over a second data transmission path;
receiving, by the redundancy transmission device, a request from the receiving device for retransmission of at least one key frame; and
in response to the request, transmitting the at least one key frame to the receiving device.

2. A method for transmitting video data, comprising:
transmitting, by a video transmission system, a video data stream to a receiving device over a first data transmission path; and
transmitting, by the video transmission system, data representing one or more key frames included in the video data stream to a redundancy transmission device over a second data transmission path, the redundancy transmission device being configured to transmit at least one key frame to the receiving device in response to a request for retransmission of the at least one key frame.

3. The method of claim 2, wherein the video data stream and the data are transmitted wirelessly.

4. The method of claim 2, wherein the first data transmission path and the second data transmission path are wireless channels.

5. The method of claim 2, wherein the video data stream comprises compressed video data that includes key frame data.

6. The method of claim 5, wherein the request is generated in response to a loss of at least one of the one or more of the key frames.

7. The method of claim 5, wherein the redundancy transmission device is a router.

8. The method of claim 2, wherein the receiving device is a computing device configured to decompress the video data stream.

9. A system for facilitating wireless data transmission, comprising:
a computing device comprising at least one processor;
a memory communicatively coupled to the processor when the system is operational, the memory having stored therein computer instructions that upon execution by the at least one processor cause the system to:
receive data representing one or more key frames of a data stream over a first wireless channel;
transmit the data stream to a receiving device over a second wireless channel;
receive a request from the receiving device for retransmission of at least one of the one or more key frames; and
in response to the request, transmit the requested at least one key frame to the receiving device.

10. The system of claim 9, wherein the data stream comprises compressed video data.

11. The system of claim 9, wherein the requested at least one key frame is transmitted over a third wireless channel.

12. The system of claim 9, wherein the request is generated in response to a loss of some of one or more of the key frames.

13. The system of claim 9, wherein the receiving device is a computing device configured to decompress the data stream.

14. A system for receiving data transmissions comprising:
means for receiving a data stream from a data transmission system over a first data transmission path, the data stream including one or more key frames;
means for sending, to a redundancy transmission device, a request for retransmission of at least one of the one or more key frames, wherein the one or more key frames are received by the redundancy transmission device from the data transmission system over a second data transmission path; and
means for receiving, from the redundancy transmission device, data representing the at least one of the one or more key frames.

15. The system of claim 14, wherein the data stream is transmitted wirelessly.

16. The system of claim 15, wherein the first data transmission path and the second data transmission path are wireless channels.

17. The system of claim 14, wherein the data stream comprises compressed video data that includes the key frames.

18. The system of claim 14, wherein the request is generated in response to a loss of some of one or more of the key frames.

19. The system of claim 14, wherein the receiving the data representing the at least one key frame is received over a third data transmission path.

20. The system of claim 17, further comprising means to decompress the compressed video data.
